(19) United States
(12) Patent Application Publication
(10) Pub. No.: US 2023/0313500 A1
(43) Pub. Date: Oct. 5, 2023

(54) WORK VEHICLE

(71) Applicant: KOMATSU LTD., Minato-ku, Tokyo (JP)

(72) Inventors: Ippei SUZUKI, Minato-ku, Tokyo (JP); Kei SHINOHARA, Minato-ku, Tokyo (JP); Kiwa TAKEDA, Minato-ku, Tokyo (JP)

(73) Assignee: KOMATSU LTD., Minato-ku, Tokyo (JP)

(21) Appl. No.: 18/024,619

(22) PCT Filed: Jul. 20, 2021
(86) PCT No.: PCT/JP2021/027058

§ 371 Date: Mar. 3, 2023

(30) Foreign Application Priority Data
Sep. 15, 2020 (JP) 2020-154337

(51) Int. Cl. E02F 9/24; E02F 9/26; E02F 9/08; E02F 9/18; E02F 9/16; G01S 13/931

(52) U.S. Cl. CPC E02F 9/24; E02F 9/261; E02F 9/0808; E02F 9/18; E02F 9/16; G01S 13/931; G01S 2013/93274; G01S 2013/93272

(57) ABSTRACT

A hydraulic excavator which is a work vehicle includes a traveling apparatus, a revolution frame mounted on the traveling apparatus and including a lower frame, and a first radar arranged on a side surface of the lower frame, the side surface of the lower frame extending in a fore/aft direction and being arranged on left and right, the first radar being provided at a position closer to a rear end portion of the lower frame.

### TECHNICAL FIELD

The present disclosure relates to a work vehicle.

### BACKGROUND ART

For example, Japanese Patent Laying-Open No. 2008-163719 (PTL 1) discloses a hydraulic excavator including a lower traveling unit and an upper revolving unit revolvably mounted on the lower traveling unit. An obstacle detector implemented by a laser radar is provided on each of left and right side surfaces and front and rear surfaces of the upper revolving unit.

### CITATION LIST

### Patent Literature

PTL 1: Japanese Patent Laying-Open No. 2008-163719

### SUMMARY OF INVENTION

### Technical Problem

As disclosed in PTL 1 described above, a sensor such as a radar has been used to detect an object such as a person or a structure around a hydraulic excavator. In this case, generally, a work vehicle such as a hydraulic excavator is large and an operator gets on board the vehicle at high elevations. Therefore, enhanced capability to detect an object located in the rear of a side surface of the work vehicle and around the ground has been demanded.

An object of the present disclosure is to solve the problem above and to provide a work vehicle that achieves enhanced capability to detect an object located in the rear of a side surface of the work vehicle and around the ground.

### Solution to Problem

A work vehicle according to the present disclosure includes a traveling apparatus, a revolution frame, and a first obstacle detection sensor. The revolution frame is mounted on the traveling apparatus. The revolution frame includes a lower frame. The first obstacle detection sensor is arranged on a side surface of the lower frame that extends in a fore/aft direction and is arranged on the left and the right. The first obstacle detection sensor is provided at a position closer to a rear end portion of the lower frame.

### Advantageous Effects of Invention

According to the present disclosure, a work vehicle that achieves enhanced capability to detect an object located in the rear of a side surface of the work vehicle and around the ground can be provided.

### BRIEF DESCRIPTION OF DRAWINGS

FIG. 1 is a perspective view showing a hydraulic excavator.

FIG. 2 is a top view showing a frame structure of a revolving unit and a counterweight in FIG. 1.

FIG. 3 is a perspective view showing the frame structure of the revolving unit and the counterweight in FIG. 1.

FIG. 4 is another perspective view showing the frame structure of the revolving unit and the counterweight in FIG. 1.

FIG. 5 is a left side view showing the hydraulic excavator in FIG. 1.

FIG. 6 is a right side view showing the hydraulic excavator in FIG. 1.

FIG. 7 is a perspective view showing the hydraulic excavator in a region (except for a lid portion) surrounded by a chain double-dotted line VII in FIG. 3.

FIG. 8 is a rear view showing the hydraulic excavator in FIG. 1.

FIG. 9 is a perspective view showing the hydraulic excavator in a region (except for a lid portion) surrounded by a chain double-dotted line IX in FIG. 3.

FIG. 10 is a top view showing areas of detection by radars and cameras around the hydraulic excavator in FIG. 1.

FIG. 11 is a perspective view showing the area of detection by the radars around the hydraulic excavator in FIG. 1.

FIG. 12 is a cross-sectional view showing the hydraulic excavator in a direction along the line XII-XII in FIG. 3.

FIG. 13 is a cross-sectional view of the hydraulic excavator in FIG. 12 from which a bolt for fastening an attachment plate was removed.

FIG. 14 is a rear view showing change of a first left radar detection area in adjustment of an attachment attitude of a first left radar.

FIG. 15 is a rear view showing change of the first left radar detection area in adjustment of the attachment attitude of the first left radar.

FIG. 16 is a rear view showing change of the first left radar detection area in adjustment of the attachment attitude of the first left radar.

FIG. 17 is a rear view showing change of the first left radar detection area in adjustment of the attachment attitude of the first left radar.

FIG. 18 is a perspective view showing change in positional relation between the first left radar detection area and a traveling apparatus in adjustment of the attachment attitude of the first left radar.

FIG. 19 is a perspective view showing change in positional relation between the first left radar detection area and the traveling apparatus in adjustment of the attachment attitude of the first left radar.

FIG. 20 is a cross-sectional view showing the hydraulic excavator in a direction along the line XX-XX in FIG. 3.

### DESCRIPTION OF EMBODIMENTS

An embodiment of the present disclosure will be described with reference to the drawings. The same or corresponding members in the drawings referred to below have the same reference characters allotted.

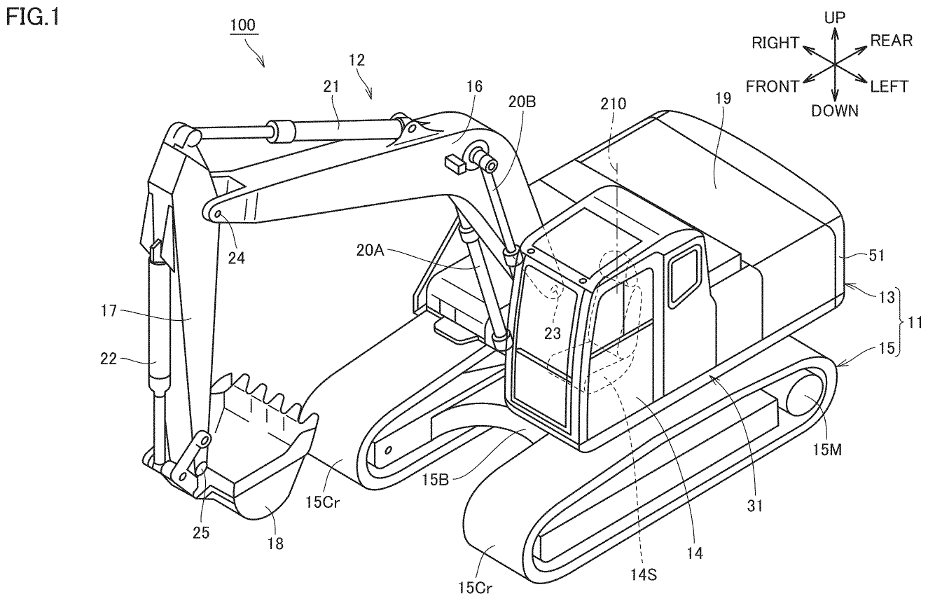

FIG. 1 is a perspective view showing a hydraulic excavator. As shown in FIG. 1, a hydraulic excavator 100 includes a vehicular main body 11 and a work implement 12. Vehicular main body 11 includes a revolving unit 13 and a traveling apparatus 15.

Revolving unit 13 is provided on traveling apparatus 15. Revolving unit 13 is revolvable around a revolution center axis 210 with respect to traveling apparatus 15. Revolution center axis 210 is an axis extending in an upward/downward direction. Revolving unit 13 includes a cab (operator's cab) 14. An operator's seat 14S is provided in cab 14. An operator enters cab 14 and operates hydraulic excavator 100 while the operators sits in operator's seat 14S.

The fore/aft direction herein refers to the fore/aft direction of an operator who sits in operator's seat 14S. A direction in which the operator sitting in operator's seat 14S faces is defined as the fore direction and a direction behind the operator sitting in operator's seat 14S is defined as the aft direction. A lateral (side) direction refers to a lateral direction of the operator who sits in operator's seat 14S. A right side and a left side at the time when the operator sitting in operator's seat 14S faces front are defined as the right direction and the left direction, respectively. An upward/downward direction is a direction orthogonal to the plane including the fore/aft direction and the lateral direction. A side where the ground is located is defined as a lower side and a side where the sky is located is defined as an upper side.

Revolving unit 13 further includes an engine hood 19 and a counterweight 51. An engine, a hydraulic oil tank, an air cleaner, a hydraulic pump, and the like are accommodated in engine hood 19. Counterweight 51 is provided in the rear of engine hood 19.

Traveling apparatus 15 includes a travel frame 15B, a pair of left and right crawler belts 15Cr, and a travel motor 15M.

Travel frame 15B is a frame body that serves as a base for traveling apparatus 15, and supports crawler belts 15Cr and travel motor 15M thereon. Hydraulic excavator 100 can travel as crawler belts 15Cr rotate. Travel motor 15M is provided as a drive source of traveling apparatus 15. Travel motor 15M is a hydraulic motor driven by supply of hydraulic oil. Traveling apparatus 15 may include a wheel (tire).

Work implement 12 is attached to vehicular main body 11. Work implement 12 is attached to revolving unit 13. Work implement 12 do such works as excavation of the ground. Work implement 12 includes a boom 16, an arm 17, and a bucket 18.

Boom 16 is pivotably coupled to vehicular main body 11 (revolving unit 13) with a boom pin 23 being interposed. Arm 17 is pivotably coupled to boom 16 with an arm pin 24 being interposed. Bucket 18 is pivotably coupled to arm 17 with a bucket pin 25 being interposed.

Work implement 12 further includes a boom cylinder 20A and a boom cylinder 20B, an arm cylinder 21, and a bucket cylinder 22.

Boom cylinder 20A, boom cylinder 20B, arm cylinder 21, and bucket cylinder 22 are each a hydraulic cylinder driven by hydraulic oil. Boom cylinder 20A and boom cylinder 20B are provided on opposing sides of boom 16 as a pair and they have boom 16 pivotally operate. Arm cylinder 21 has arm 17 pivotally operate. Bucket cylinder 22 has bucket 18 pivotally operate.

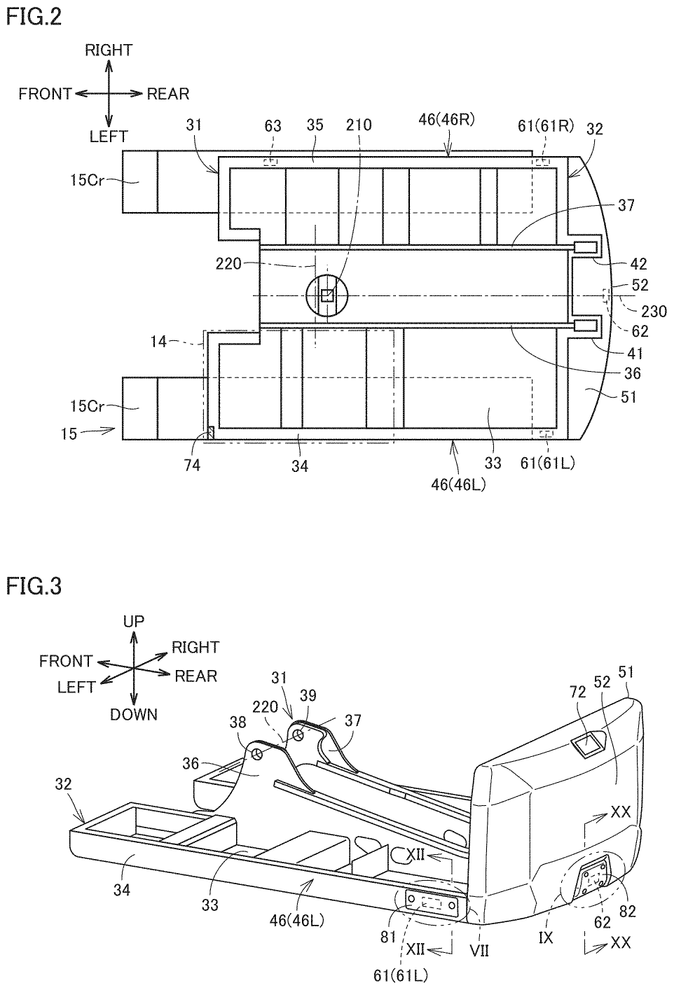

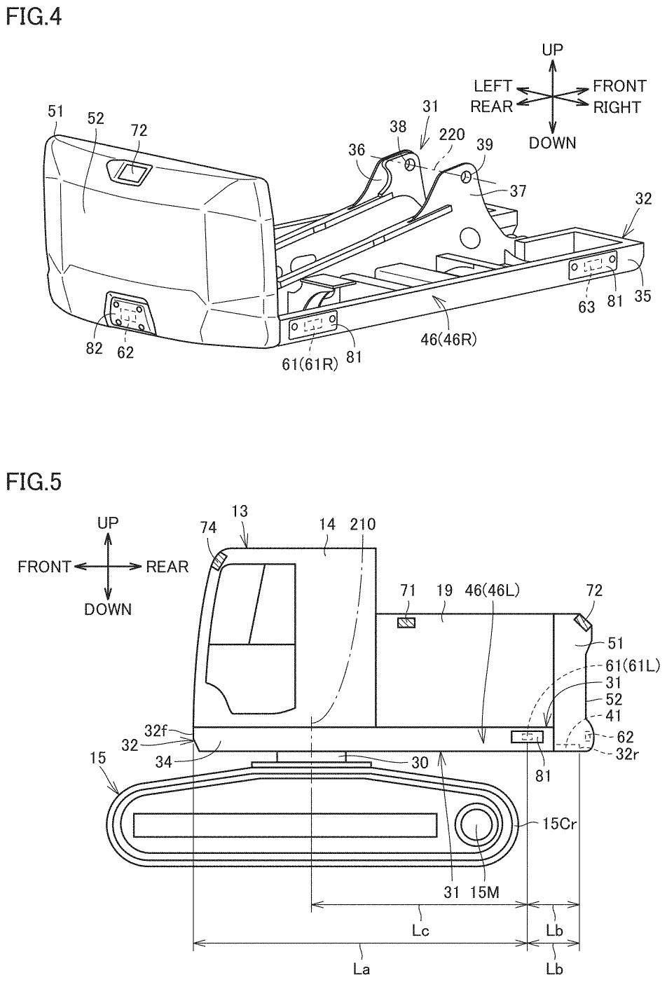

FIG. 2 is a top view showing a frame structure of the revolving unit and the counterweight in FIG. 1. FIGS. 3 and 4 are perspective views showing the frame structure of the revolving unit and the counterweight in FIG. 1.

As shown in FIGS. 2 to 4, revolving unit 13 further includes a revolution frame 31. Revolution frame 31 is a frame body that serves as the base for revolving unit 13 and formed from a steel plate. Revolution frame 31 is mounted on traveling apparatus 15. Revolution frame 31 is revolvable around revolution center axis 210 with respect to traveling apparatus 15. Revolution frame 31 is generally in a frame shape as extending in a direction orthogonal to the upward/downward direction (revolution center axis 210). Counterweight 51 is a weight made of a metal. Counterweight 51 is provided at a rear end portion of revolution frame 31.

Revolution frame 31 includes a lower frame 32 and a plurality of vertical plates 36 and 37. Lower frame 32 is provided on traveling apparatus 15. Lower frame 32 is connected to traveling apparatus 15. Lower frame 32 is connected to travel frame 15B with a revolution apparatus 30 (see FIGS. 5, 6, and 8 which will appear later) being interposed.

FIG. 2 shows a centerline 230 of lower frame 32 that passes through revolution center axis 210 and extends in the fore/aft direction. Centerline 230 is a straight line indicating the center of lower frame 32 in the lateral direction. Lower frame 32 may be constructed such that centerline 230 does not pass through revolution center axis 210.

Lower frame 32 includes a bottom plate 33, a left rising portion 34, and a right rising portion 35. Bottom plate 33 is in a plate shape that extends in the direction orthogonal to the upward/downward direction (revolution center axis 210). Left rising portion 34 is provided at a left end of bottom plate 33. Right rising portion 35 is provided at a right end of bottom plate 33. Left rising portion 34 and right rising portion 35 extend in the fore/aft direction, as being in a projecting shape that rises upward from bottom plate 33. Left rising portion 34 and right rising portion 35 are each in a bag shape having a rectangular cross-section when cut along a plane orthogonal to the fore/aft direction.

Left rising portion 34 and right rising portion 35 are each provided in a side surface 46 of lower frame 32 that extends in the fore/aft direction and is arranged on the left and the right. Left rising portion 34 is provided in a left side surface 46L of lower frame 32 arranged on the left. Right rising portion 35 is provided in a right side surface 46R of lower frame 32 arranged on the right. Side surfaces 46 face the lateral direction. Left side surface 46L faces to the left. Right side surface 46R faces to the right.

Lower frame 32 further includes a protruding portion 41 and a protruding portion 42. Protruding portion 41 and protruding portion 42 are arranged at a rear end portion of lower frame 32. Protruding portion 41 and protruding portion 42 are in a protruding shape that protrudes rearward at the rear end portion of lower frame 32. Protruding portion 41 and protruding portion 42 are provided at a distance in the lateral direction with centerline 230 of lower frame 32 lying therebetween. Counterweight 51 is provided above protruding portion 41 and protruding portion 42.

Vertical plate 36 and vertical plate 37 are erected on bottom plate 33. Vertical plate 36 and vertical plate 37 are each in a plate shape that extends in the direction orthogonal to the lateral direction. Vertical plate 36 and vertical plate 37 are arranged at a distance from each other in the lateral direction. Vertical plate 36 and vertical plate 37 are provided at a distance in the lateral direction with centerline 230 of lower frame 32 lying therebetween. Vertical plate 36 and vertical plate 37 are provided at a distance in the lateral direction with revolution center axis 210 lying therebetween.

Vertical plate 36 is provided with a pin insertion hole 38. Vertical plate 37 is provided with a pin insertion hole 39. Pin insertion hole 38 and pin insertion hole 39 are through holes that pass through vertical plate 36 and vertical plate 37, respectively. Pin insertion hole 38 and pin insertion hole 39 are arranged on a pivot center axis 220 extending in the lateral direction.

As shown in FIGS. 1 to 4, boom 16 is inserted between vertical plate 36 and vertical plate 37. Boom 16 is pivotably coupled to vertical plate 36 and vertical plate 37 by means of boom pin 23 inserted in pin insertion hole 38 and pin insertion hole 39.

In such a construction, boom 16 pivotally operates around pivot center axis 220. Pivot center axis 220 extends in the lateral direction at a position distant upward from bottom plate 33. Pivot center axis 220 is arranged in front of revolution center axis 210. Vertical plate 36 and vertical plate 37 are each in such a chevron shape as extending forward and rearward in a diagonally downward direction from a position where pivot center axis 220 of boom 16 is arranged, with the position where pivot center axis 220 of boom 16 is arranged being defined as a top portion.

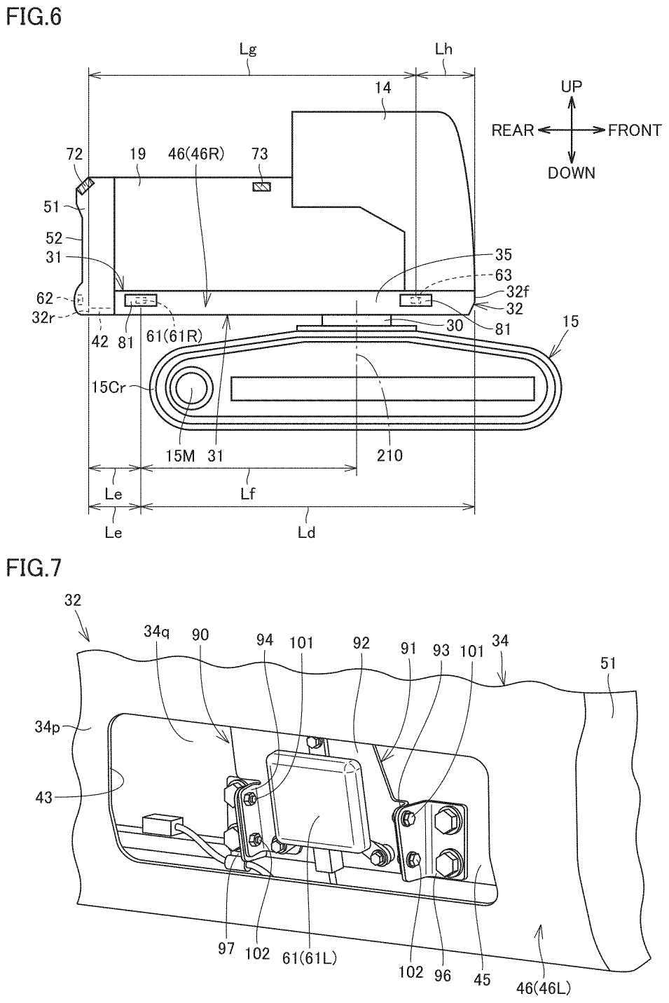

FIG. 5 is a left side view showing the hydraulic excavator in FIG. 1. FIG. 6 is a right side view showing the hydraulic excavator in FIG. 1.

As shown in FIGS. 2 to 6, hydraulic excavator 100 further includes a first radar 61. First radar 61 is, for example, a millimeter wave radar apparatus that emits radio waves in a 20 to 300 GHz band. First radar 61 is arranged on side surface 46 of lower frame 32.

Hydraulic excavator 100 includes a first left radar 61L and a first right radar 61R as first radar 61. First left radar 61L is arranged on left side surface 46L of lower frame 32. First left radar 61L is attached to left rising portion 34 of lower frame 32. First right radar 61R is arranged on right side surface 46R of lower frame 32. First right radar 61R is attached to right rising portion 35 of lower frame 32.

As shown in FIGS. 5 and 6, first radar 61 is provided at a position closer to a rear end portion 32r of lower frame 32. First radar 61 is provided at a position closer to rear end portion 32r of lower frame 32 than to a front end portion 32f of lower frame 32 in the fore/aft direction.

As shown in FIG. 5, a distance Lb between rear end portion 32r of lower frame 32 and first left radar 61L in the fore/aft direction is shorter than a distance La between front end portion 32f of lower frame 32 and first left radar 61L in the fore/aft direction (Lb<La). As shown in FIG. 6, a distance Le between rear end portion 32r of lower frame 32 and first right radar 61R in the fore/aft direction is shorter than a distance Ld between front end portion 32f of lower frame 32 and first right radar 61R in the fore/aft direction (Le<Ld).

As shown in FIGS. 5 and 6, revolution center axis 210 is arranged in front of first radar 61. First radar 61 is provided at a position closer to rear end portion 32r of lower frame 32 than to revolution center axis 210 in the fore/aft direction.

As shown in FIG. 5, distance Lb between rear end portion 32r of lower frame 32 and first left radar 61L in the fore/aft direction is shorter than a distance Lc between revolution center axis 210 and first left radar 61L in the fore/aft direction (Lb<Lc). As shown in FIG. 6, distance Le between rear end portion 32r of lower frame 32 and first right radar 61R in the fore/aft direction is shorter than a distance Lf between revolution center axis 210 and first right radar 61R in the fore/aft direction (Le<Lf).

A reference position in specifying a position of a radar in a prescribed direction herein is set to a central position of the radar in the prescribed direction.

As shown in FIGS. 2 to 6, first radar 61 is provided in the rear of pivot center axis 220 of boom 16. First radar 61 is provided in the rear of cab 14. First radar 61 is provided between cab 14 and counterweight 51 in the fore/aft direction. First radar 61 is provided in the rear of traveling apparatus 15. First radar 61 is provided in the rear of the pair of crawler belts 15Cr. First radar 61 is provided in the rear of travel motor 15M. First radar 61 is provided in front of counterweight 51.

First radar 61 is provided below pivot center axis 220 of boom 16. First radar 61 is provided below engine hood 19. First radar 61 is provided below cab 14. First radar 61 is provided below operator's seat 14S in FIG. 1. First left radar 61L and first right radar 61R are provided at positions at the same height. First left radar 61L and first right radar 61R may be provided at positions at heights different from each other.

First left radar 61L and first right radar 61R are provided at positions symmetric to each other with respect to centerline 230 of lower frame 32. First left radar 61L and first right radar 61R may be provided at positions asymmetric to each other with respect to centerline 230 of lower frame 32.

FIG. 7 is a perspective view showing the hydraulic excavator in a region (except for a lid portion) surrounded by a chain double-dotted line VII in FIG. 3.

As shown in FIGS. 2, 3, and 7, lower frame 32 is provided with a recess portion 45. Recess portion 45 is in a recessed shape in left side surface 46L of lower frame 32.

More specifically, left rising portion 34 includes an outer plate portion 34p and an inner plate portion 34q. Outer plate portion 34p and inner plate portion 34q are each in a plate shape extending in the direction orthogonal to the lateral direction. Outer plate portion 34p and inner plate portion 34q extend such that the fore/aft direction is defined as a longitudinal direction thereof while they are opposed to each other at a distance from each other in the lateral direction. Outer plate portion 34p is arranged on an outer side of lower frame 32 relative to inner plate portion 34q. A length of lower frame 32 between centerline 230 and outer plate portion 34p in the lateral direction is longer than a length of lower frame 32 between centerline 230 and inner plate portion 34q in the lateral direction.

Outer plate portion 34p is provided with an opening portion 43. Opening portion 43 is provided as a through hole that passes through outer plate portion 34p in the lateral direction. Opening portion 43 is in such a rectangular opening shape that the fore/aft direction is defined as a direction of a long side thereof and the upward/downward direction is defined as a direction of a short side thereof. According to such a construction, lower frame 32 is provided with recess portion 45 that opens to the left through opening portion 43 and is recessed from outer plate portion 34p toward inner plate portion 34q.

First left radar 61L is accommodated in recess portion 45. First left radar 61L is attached to inner plate portion 34q by an attachment member 90 which will be described later.

Hydraulic excavator 100 further includes a lid portion 81. Lid portion 81 is made of a resin. Lid portion 81 is attached to lower frame 32 to close the opening in recess portion 45. Lid portion 81 is attached to outer plate portion 34p to close opening portion 43.

Though an attachment structure for first left radar 61L is described, first right radar 61R is also attached to right rising portion 35 of lower frame 32 in a manner similar to first left radar 61L.

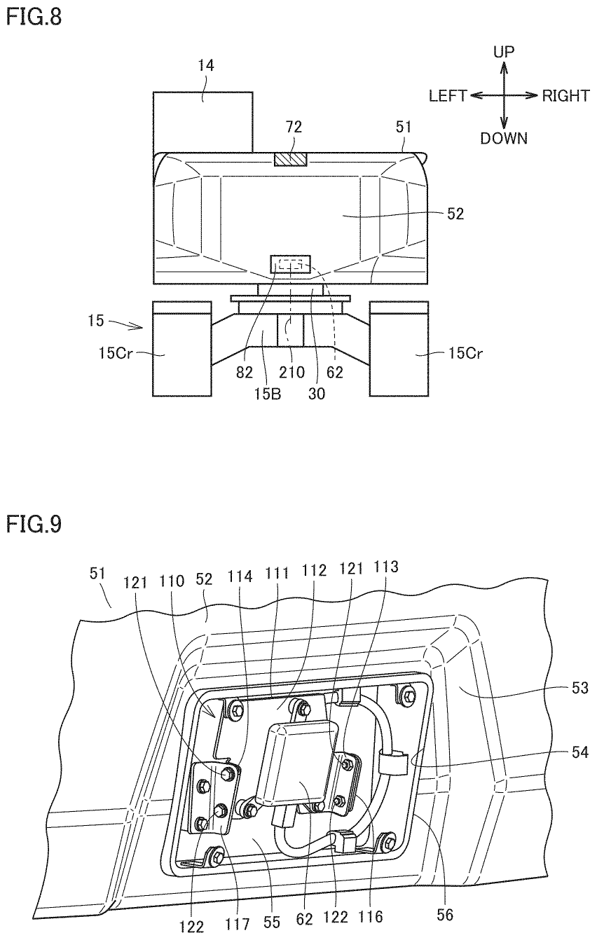

FIG. 8 is a rear view showing the hydraulic excavator in FIG. 1. As shown in FIGS. 2 to 4 and 8, hydraulic excavator 100 further includes a second radar 62. Second radar 62 is, for example, a millimeter radar apparatus that emits radio waves in a 20 to 300 GHz band. Second radar 62 is arranged on a rear surface 52 of counterweight 51.

Rear surface 52 faces the rear.

Second radar 62 is provided in the rear of first radar 61. Second radar 62 is provided at a position superimposed on centerline 230 of lower frame 32 in a top view. Second radar 62 is provided at a lower end of counterweight 51. Second radar 62 is provided at a position higher than first radar 61. Second radar 62 may be provided at a position displaced from centerline 230 of lower frame 32 in the top view, a position lower than first radar 61, or a position as high as first radar 61.

FIG. 9 is a perspective view showing the hydraulic excavator in a region (except for the lid portion) surrounded by a chain double-dotted line IX in FIG. 3.

As shown in FIGS. 3, 4, and 9, counterweight 51 is provided with a recess portion 55. Recess portion 55 is in a recessed shape in rear surface 52 of counterweight 51.

More specifically, counterweight 51 is provided with a dished portion 53. Dished portion 53 is in a shape dished forward from rear surface 52 of counterweight 51. Counterweight 51 is provided with an opening portion 54. Opening portion 54 is provided at the bottom of dished portion 53.

Counterweight 51 includes a casing body 56. Casing body 56 is in a dish shape that opens in one direction. Casing body 56 is inserted in opening portion 54 to open rearward. According to such a construction, counterweight 51 is provided with recess portion 55 that opens rearward and is delimited in the inside of casing body 56. Recess portion 55 is provided at a position deeper than dished portion 53.

Second radar 62 is accommodated in recess portion 55. Second radar 62 is attached to casing body 56 by an attachment member 110 which will be described later.

Hydraulic excavator 100 further includes a lid portion 82. Lid portion 82 is made of a resin. Lid portion 82 is attached to counterweight 51 to close the opening in recess portion 55. Lid portion 82 is attached to casing body 56 to close the opening in casing body 56. Lid portion 82 is arranged in dished portion 53.

As shown in FIGS. 2 and 5, cab 14 is provided on lower frame 32. Cab 14 is provided at a position shifted to the left with respect to centerline 230 of lower frame 32.

As shown in FIGS. 2, 4, and 6, hydraulic excavator 100 further includes a third radar 63. Third radar 63 is, for example, a millimeter radar apparatus that emits radio waves in a 20 to 300 GHz band.

Third radar 63 is arranged on right side surface 46R of lower frame 32. Third radar 63 is provided opposite to cab 14 with respect to centerline 230 of lower frame 32. Third radar 63 is attached to right rising portion 35 of lower frame 32 in a manner the same as first right radar 61R.

As shown in FIG. 6, third radar 63 is provided at a position closer to front end portion 32f of lower frame 32. Third radar 63 is provided at a position closer to front end portion 32f of lower frame 32 than to rear end portion 32r of lower frame 32 in the fore/aft direction. A distance Lh between front end portion 32f of lower frame 32 and third radar 63 in the fore/aft direction is shorter than a distance Lg between rear end portion 32r of lower frame 32 and third radar 63 in the fore/aft direction (Lh<Lg).

As shown in FIGS. 2 and 6, third radar 63 is provided in front of first radar 61. Third radar 63 is provided in front of revolution center axis 210. Third radar 63 is provided in front of pivot center axis 220 of boom 16. In the top view shown in FIG. 2, third radar 63 is provided at a position opposed to cab 14 with centerline 230 of lower frame 32 lying therebetween.

Third radar 63 is provided at a position as high as first radar 61. Third radar 63 may be provided at a position different in height from first radar 61. By way of example, the height where first radar 61, second radar 62, and third radar 63 are provided is within a range not lower than 1 m and not higher than 1.5 m with the ground where hydraulic excavator 100 travels being defined as the reference.

As shown in FIGS. 5, 6, and 8, hydraulic excavator 100 further includes a first camera 71, a second camera 72, a third camera 73, and a fourth camera 74. First camera 71, second camera 72, third camera 73, and fourth camera 74 are each, for example, a camera of a monocular type, and contains an image pick-up element such as a charge coupled device (CCD) or a complementary metal oxide semiconductor (CMOS).

First camera 71 is arranged on a left side surface of revolving unit 13 that faces to the left. First camera 71 is attached to an upper exterior of revolving unit 13. First camera 71 is provided in front of first left radar 61L. First camera 71 is provided in the rear of revolution center axis 210. First camera 71 is provided in the rear of pivot center axis 220 of boom 16. First camera 71 is provided above first left radar 61L.

Second camera 72 is arranged on a rear surface of revolving unit 13 that faces the rear. Second camera 72 is provided in counterweight 51. Second camera 72 is provided at a position superimposed on centerline 230 of lower frame 32 in the top view. Second camera 72 is provided at an upper end of counterweight 51. Second camera 72 is provided above second radar 62.

Third camera 73 is arranged on a right side surface of revolving unit 13 that faces to the right. Third camera 73 is attached to engine hood 19. Third camera 73 is provided in front of first right radar 61R. Third camera 73 is provided between third radar 63 and first right radar 61R in the fore/aft direction. Third camera 73 is provided in the rear of revolution center axis 210. Third camera 73 is provided in the rear of pivot center axis 220 of boom 16. Third camera 73 is provided above first right radar 61R and third radar 63.

First camera 71, second camera 72, and third camera 73 are provided at positions at the same height. First camera 71, second camera 72, and third camera 73 may be provided at positions at heights different from one another.

As shown in FIGS. 2 and 5, fourth camera 74 is arranged on a front surface of revolving unit 13 that faces the front. Fourth camera 74 is attached to cab 14.

Fourth camera 74 is provided at an upper left corner of a front surface of cab 14. Fourth camera 74 is provided in front of revolution center axis 210. Fourth camera 74 is provided in front of pivot center axis 220 of boom 16. Fourth camera 74 is provided above first camera 71, second camera 72, and third camera 73.

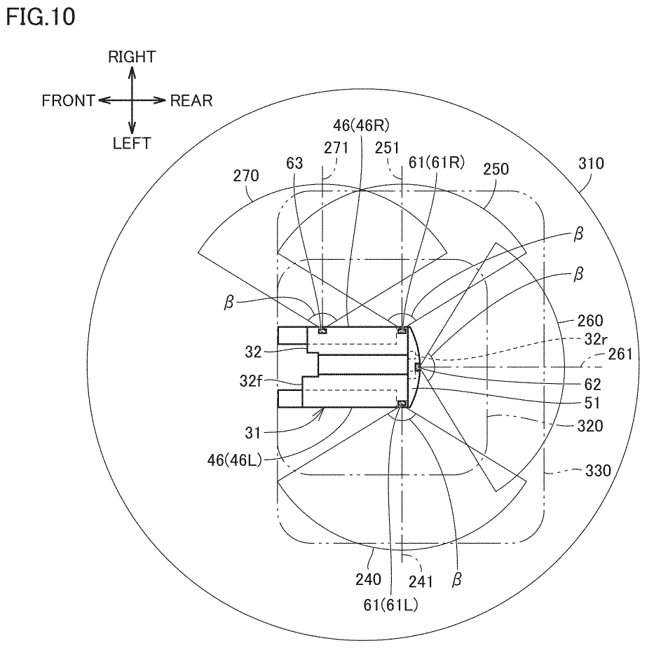

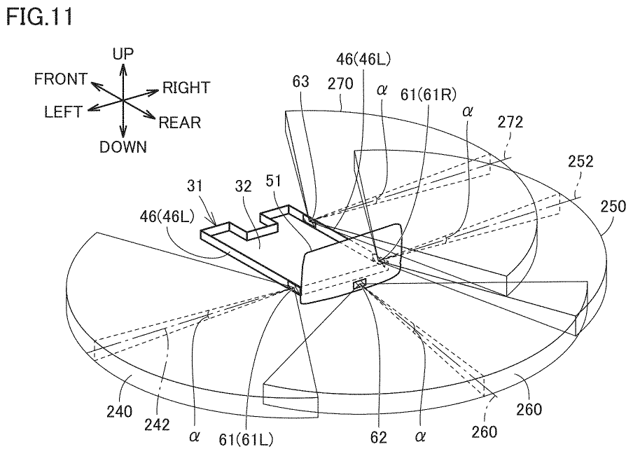

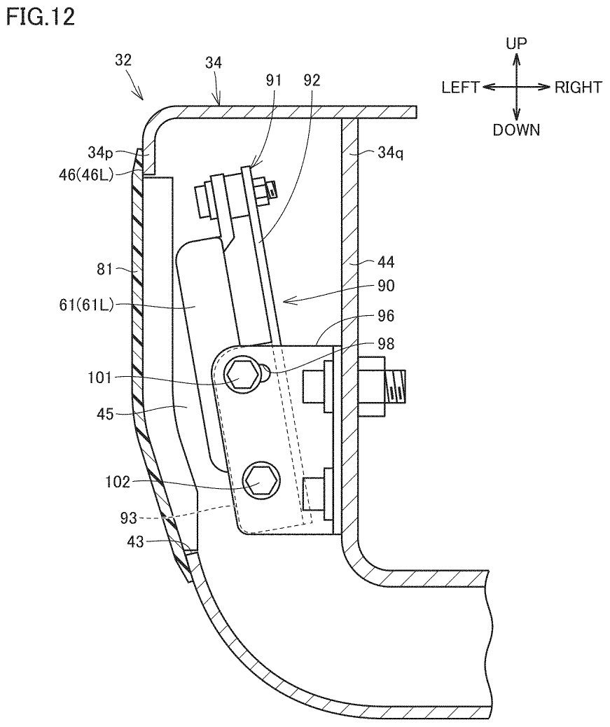

FIG. 10 is a top view showing areas of detection by the radars and the cameras around the hydraulic excavator in FIG. 1. FIG. 11 is a perspective view showing the areas of detection by the radars around the hydraulic excavator in FIG. 1.

As shown in FIGS. 10 and 11, first left radar 61L, first right radar 61R, second radar 62, and third radar 63 emit radio waves to areas around hydraulic excavator 100 and receive radio waves reflected by an object located around hydraulic excavator 100, to thereby detect the object. First left radar 61L, first right radar 61R, second radar 62, and third radar 63 form a first left radar detection area 240, a first right radar detection area 250, a second radar detection area 260, and a third radar detection area 270 as ranges of emission of radio waves from them, respectively.

First left radar detection area 240, first right radar detection area 250, second radar detection area 260, and third radar detection area 270 are each a spatial area in a shape of a sector at an angle β around corresponding one of first left radar 61L, first right radar 61R, second radar 62, and third radar 63 in the top view shown in FIG. 10 and in a shape of a sector at an angle α around corresponding one of first left radar 61L, first right radar 61R, second radar 62, and third radar 63 in a vertical plane shown in FIG. 11.

By way of example, each of first left radar detection area 240, first right radar detection area 250, second radar detection area 260, and third radar detection area 270 has a radius within a range not smaller than 0.25 m and not larger than 5 m. Angle α is within a range not smaller than 10° and not larger than 20° and angle β is within a range not smaller than 110° and not larger than 130°.

As shown in FIG. 10, a bisector 241 of first left radar detection area 240 that bisects angle β extends to the left from first left radar 61L. First left radar detection area 240 extends as far as the front of front end portion 32f of lower frame 32 and the rear of rear end portion 32r of lower frame 32. A bisector 251 of first right radar detection area 250 that bisects angle β extends to the right from first right radar 61R. First right radar detection area 250 extends as far as the front of front end portion 32f of lower frame 32 and the rear of rear end portion 32r of lower frame 32.

Bisector 241 and bisector 251 may extend in a direction inclined with respect to the lateral direction. Bisector 241 and bisector 251 may extend in a direction inclined rearward with respect to the lateral direction.

A bisector 261 of second radar detection area 260 that bisects angle β extends rearward from second radar 62. Second radar detection area 260 partially overlaps with first left radar detection area 240 and first right radar detection area 250.

A bisector 271 of third radar detection area 270 that bisects angle β extends to the right from third radar 63. Third radar detection area 270 partially overlaps with first right radar detection area 250. Bisector 271 may extend in a direction inclined with respect to the lateral direction.

As shown in FIG. 11, a bisector 242 of first left radar detection area 240 that bisects angle α extends in a horizontal direction or a diagonally downward direction from first left radar 61L. A bisector 252 of first right radar detection area 250 that bisects angle α extends in the horizontal direction or the diagonally downward direction from first right radar 61R. A bisector 262 of second radar detection area 260 that bisects angle α extends in the horizontal direction or the diagonally downward direction from second radar 62. A bisector 272 of third radar detection area 270 that bisects angle α extends in the horizontal direction or the diagonally downward direction from third radar 63.

As shown in FIG. 10, first camera 71, second camera 72, third camera 73, and fourth camera 74 form a shooting area 310 around hydraulic excavator 100. Shooting area 310 extends over an angular range of 360° around hydraulic excavator 100. First left radar detection area 240, first right radar detection area 250, second radar detection area 260, and third radar detection area 270 are included in shooting area 310.

Images shot by first camera 71, second camera 72, third camera 73, and fourth camera 74 are shown on a monitor provided in cab 14. As an object such as a person or a structure is detected in a detection area 330 within shooting area 310, a warning may be given through representation on the monitor or a buzzer, or travel of hydraulic excavator 100 may be decelerated. Furthermore, an object such as a person or a structure is detected in a stop control area 320 within shooting area 310, travel of hydraulic excavator 100 is stopped.

Each of first left radar detection area 240, first right radar detection area 250, second radar detection area 260, and third radar detection area 270 extends as far as the outside of stop control area 320 and further as far as the outside of detection area 330. The rear end portion of each of first left radar detection area 240 and first right radar detection area 250 is located in the rear of a rear end portion of stop control area 320.

Lower frame 32 is located directly on traveling apparatus 15 in revolution frame 31 mounted on traveling apparatus 15. In hydraulic excavator 100, first left radar 61L and first right radar 61R are arranged on left side surface 46L and right side surface 46R of lower frame 32, respectively. Therefore, first left radar 61L and first right radar 61R can be provided in side portions of hydraulic excavator 100 at positions closer to the ground where hydraulic excavator 100 travels. First left radar 61L and first right radar 61R are provided at positions closer to rear end portion 32r of lower frame 32. First left radar 61L and first right radar 61R can thus be provided as being brought further closer to the rear portion of hydraulic excavator 100.

Therefore, with first left radar 61L and first right radar 61R, capability to detect an object located in the rear of the side surface of hydraulic excavator 100 and at a position close to the ground can be enhanced.

Hydraulic excavator 100 includes first camera 71, second camera 72, third camera 73, and fourth camera 74, and monitors an area for a person around hydraulic excavator 100. By providing first left radar 61L and first right radar 61R in addition to these cameras, a person who crouches on the ground in the rear of the side surface of hydraulic excavator 100 can more reliably be detected.

The distance between first radar 61 (first right radar 61R or first left radar 61L) and rear end portion 32r of lower frame 32 in the fore/aft direction is shorter than the distance between revolution center axis 210 of revolution frame 31 and first radar 61 (first right radar 61R or first left radar 61L) in the fore/aft direction. Thus, first left radar 61L and first right radar 61R can be provided as being brought further closer to the rear portion of hydraulic excavator 100 so that capability to detect an object located in the rear of the side surface of hydraulic excavator 100 can further be enhanced.

Bisector 242 of first left radar detection area 240 that bisects angle α extends from first left radar 61L in the horizontal direction or the diagonally downward direction. Bisector 252 of first right radar detection area 250 that bisects angle α extends from first right radar 61R in the horizontal direction or the diagonally downward direction. Thus, with first left radar 61L and first right radar 61R, capability to detect an object located at a position close to the ground can further be enhanced.

First left radar 61L and first right radar 61R are each accommodated in recess portion 45 provided in lower frame 32. Since first radar 61 is thus surrounded by lower frame 32 that forms the frame structure, first radar 61 can appropriately be protected by lower frame 32 even in case of external application of great impact to first radar 61.

Second radar 62 is arranged on rear surface 52 of counterweight 51. Thus, with second radar 62 together with first radar 61, capability to detect an object located in the rear of the side surface of hydraulic excavator 100 can further be enhanced.

Third radar 63 is provided at a position which is opposite to cab 14 in the lateral direction and closer to front end portion 32f of lower frame 32. Thus, with third radar 63, capability to detect an object located at a position in front of the right side surface of hydraulic excavator 100 which is difficult for the operator in cab 14 to visually recognize can be enhanced.

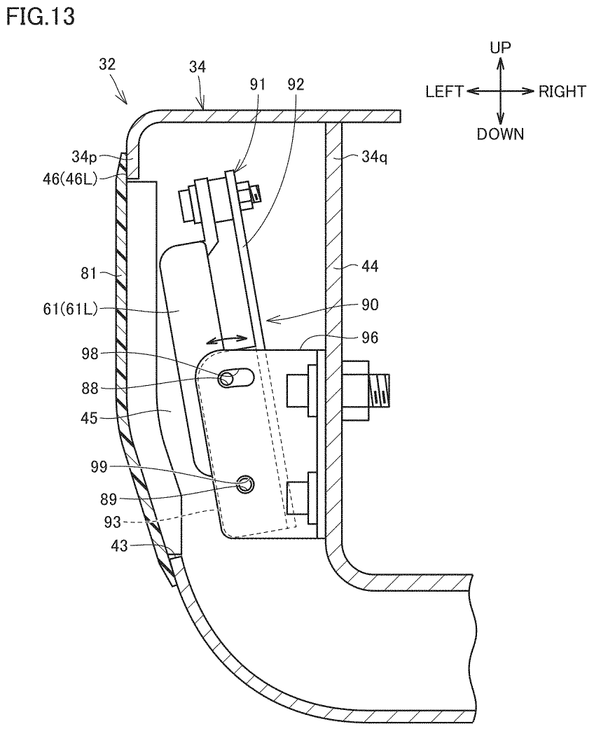

FIG. 12 is a cross-sectional view showing the hydraulic excavator in a direction along the line XII-XII in FIG. 3. FIG. 13 is a cross-sectional view of the hydraulic excavator in FIG. 12 from which a bolt for fastening an attachment plate was removed.

As shown in FIGS. 7, 11, 12, and 13, hydraulic excavator 100 further includes attachment member 90. First left radar 61L is attached to lower frame 32 by means of attachment member 90.

Attachment member 90 is provided with an attitude adjustment mechanism that changes an attitude of attachment of first left radar 61L to lower frame 32 such that the direction of extension of bisector 242 of first left radar detection area 240 that bisects angle α changes. A structure of the attitude adjustment mechanism provided in attachment member 90 will be described below.

Attachment member 90 includes a radar attachment plate 91 and radar attachment angles 96 and 97. First left radar 61L is attached to inner plate portion 34q of left rising portion 34 in lower frame 32 with radar attachment plate 91 and radar attachment angles 96 and 97 being interposed.

Radar attachment plate 91 includes a flat plate portion 92 and bent portions 93 and 94. Flat plate portion 92 is in a plate shape extending in a direction intersecting with the lateral direction. First left radar 61L is fastened to flat plate portion 92 with a bolt. Bent portion 93 is bent from a front end portion of flat plate portion 92 toward the opening of opening portion 43. Bent portion 94 is bent from a rear end portion of flat plate portion 92 toward the opening of opening portion 43. Bent portion 93 and bent portion 94 are each provided with a bolt insertion hole 88 and a bolt insertion hole 89. Bolt insertion hole 88 is provided above bolt insertion hole 89.

Radar attachment angle 96 and radar attachment angle 97 are each an L-shaped angle. Radar attachment angle 96 and radar attachment angle 97 are arranged at a distance from each other in the fore/aft direction. Radar attachment angle 96 and radar attachment angle 97 are fastened to inner plate portion 34q with a bolt. Radar attachment angle 96 and radar attachment angle 97 are each provided with a long hole 98 and a round hole 99. Long hole 98 is provided above round hole 99. Round hole 99 is in a shape of an annular opening. Long hole 98 is in a shape of a long hole extending in an arc around round hole 99, with a constant width in a direction of radius of round hole 99.

Bent portion 93 and bent portion 94 are fastened to radar attachment angle 96 and radar attachment angle 97, respectively, with a bolt 101 and a bolt 102. Bolt 101 is inserted in long hole 98 and bolt insertion hole 88. Bolt 102 is inserted in round hole 99 and bolt insertion hole 89.

In such a construction, by moving a position of fastening of bolt 101 to long hole 98 in a circumferential direction around round hole 99, the attitude of attachment of first left radar 61L to lower frame 32 can be adjusted to change the direction of extension of bisector 242 of first left radar detection area 240 that bisects angle α.

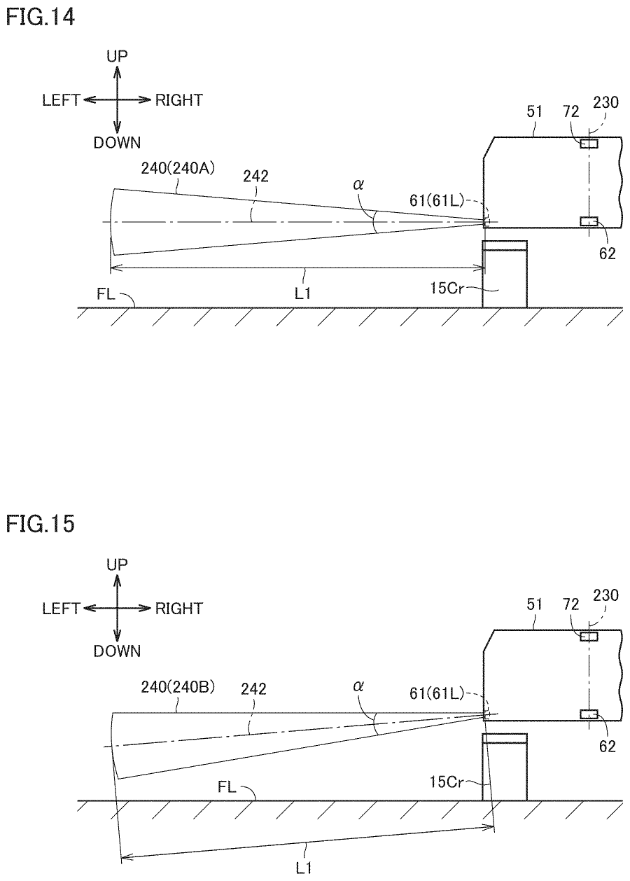

FIGS. 14 to 17 are rear views showing change of the first left radar detection area in adjustment of the attachment attitude of the first left radar.

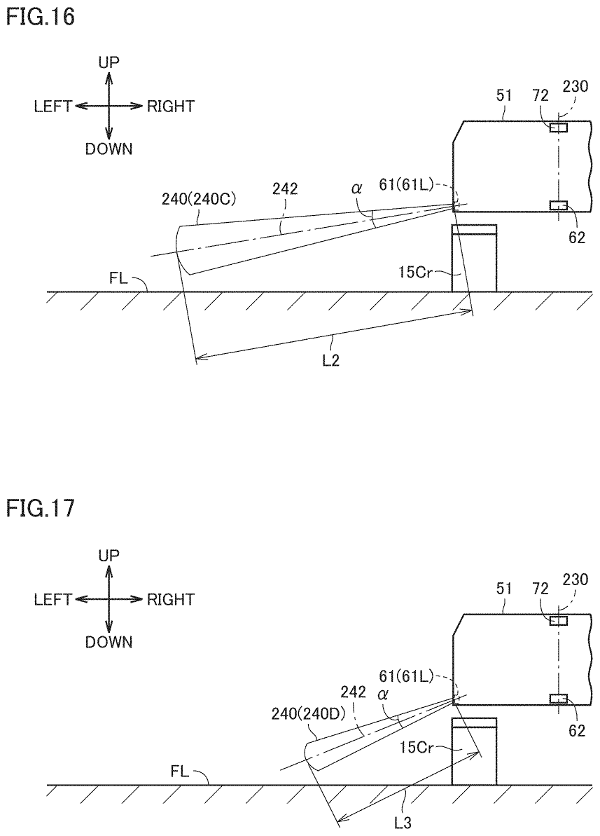

FIG. 14 shows first left radar detection area 240 (240A) when the direction of extension of bisector 242 is set to the horizontal direction, FIG. 15 shows first left radar detection area 240 (240B) when the direction of extension of bisector 242 is set to the diagonally downward direction at an angle of 5° with respect to the horizontal direction, FIG. 16 shows first left radar detection area 240 (240C) when the direction of extension of bisector 242 is set to the diagonally downward direction at an angle of 10° with respect to the horizontal direction, and FIG. 17 shows first left radar detection area 240 (240D) when the direction of extension of bisector 242 is set to the diagonally downward direction at an angle of 25° with respect to the horizontal direction.

As shown in FIGS. 14 and 15, when the direction of extension of bisector 242 is set to the horizontal direction or the diagonally downward direction at a relatively small angle with respect to the horizontal direction, an object located at a position lower than the height where first left radar 61L is provided can be detected with first left radar 61L. Though the length of first left radar detection area 240A or 240B in the upward/downward direction increases as the distance from first left radar 61L increases, a ground FL is not erroneously detected even at a position distant from first left radar 61L by a radius L1 of first left radar detection area 240A or 240B.

As shown in FIG. 16, when the direction of extension of bisector 242 is set to the diagonally downward direction at an angle of intermediate magnitude with respect to the horizontal direction, an object located at a position closer to first left radar 61L and lower than in the example shown in FIGS. 14 and 15 can be detected with first left radar 61L. In order to avoid erroneous detection of ground FL at a position distant from first left radar 61L, on the other hand, a small radius L2 of first left radar detection area 240C should be set (L2<L1).

As shown in FIG. 17, when the direction of extension of bisector 242 is set to the diagonally downward direction at a relatively large angle with respect to the horizontal direction, an object located at a position further closer to first left radar 61L and further lower than in an example shown in FIG. 16 can be detected with first left radar 61L. In order to avoid erroneous detection of ground FL at a position distant from first left radar 61L, on the other hand, a smaller radius L3 of first left radar detection area 240D should be set (L3<L2).

In hydraulic excavator 100, in consideration of the distance from first left radar 61L to an object to be detected or the height from ground FL to the object to be detected, the attachment attitude of first left radar 61L can be adjusted.

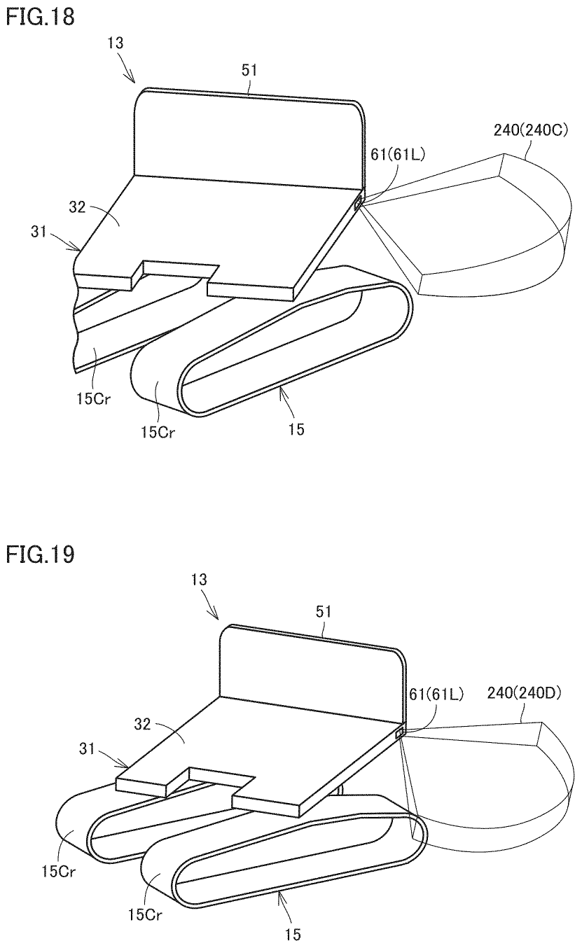

FIGS. 18 and 19 are perspective views showing change in positional relation between the first left radar detection area and the traveling apparatus in adjustment of the attachment attitude of the first left radar.

First left radar detection area 240C shown in FIG. 18 corresponds to first left radar detection area 240C shown in FIG. 16, and first left radar detection area 240D shown in FIG. 19 corresponds to first left radar detection area 240D shown in FIG. 17.

As revolution frame 31 revolves with respect to traveling apparatus 15, crawler belts 15Cr of traveling apparatus 15 are positioned in the diagonally downward direction of first left radar 61L.

As shown in FIGS. 16 and 18, when the direction of extension of bisector 242 is set to the diagonally downward direction at an angle of intermediate magnitude with respect to the horizontal direction, first left radar detection area 240C in revolution of revolution frame 31 is distant from traveling apparatus 15 (crawler belts 15Cr). When the direction of extension of bisector 242 is set to the horizontal direction or the diagonally downward direction at a relatively small angle with respect to the horizontal direction shown in FIGS. 14 and 15 as well, first left radar detection area 240A or 240B in revolution of revolution frame 31 is distant from traveling apparatus 15 (crawler belts 15Cr).

As shown in FIGS. 17 and 19, on the other hand, when the direction of extension of bisector 242 is set to the diagonally downward direction at a relatively large angle with respect to the horizontal direction, first left radar detection area 240D in revolution of revolution frame 31 interferes with traveling apparatus 15 (crawler belts 15Cr). Therefore, in determining the attachment attitude of first left radar 61L, prevention of erroneous detection of traveling apparatus 15 (crawler belts 15Cr) is also taken into account.

Though first left radar 61L is representatively described, an attitude adjustment mechanism similar to that for first left radar 61L is also provided for first right radar 61R. As the attachment attitude of first right radar 61R is adjusted, first right radar detection area 250 also changes similarly to first left radar detection area 240.

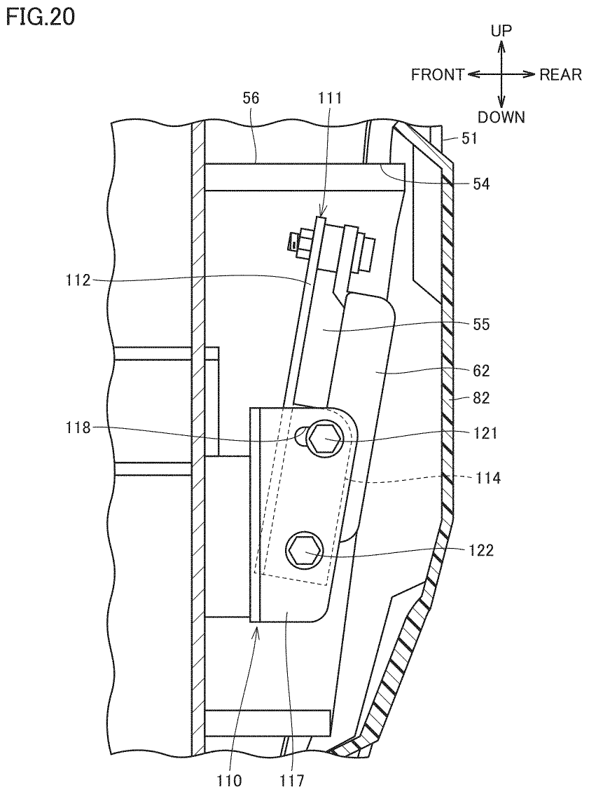

FIG. 20 is a cross-sectional view showing the hydraulic excavator in a direction along the line XX-XX in FIG. 3. As shown in FIGS. 9 and 20, hydraulic excavator 100 further includes attachment member 110. Second radar 62 is attached to counterweight 51 by means of attachment member 110.

Attachment member 110 is provided with an attitude adjustment mechanism that changes an attitude of attachment of second left radar 62 to counterweight 51 such that the direction of extension of bisector 262 of second radar detection area 260 that bisects angle α in FIG. 11 changes. The attitude adjustment mechanism provided in attachment member 110 is similar in structure to the attitude adjustment mechanism provided in attachment member 90 shown in FIGS. 7, 12, and 13.

Attachment member 110 includes a radar attachment plate 111 and radar attachment angles 116 and 117. Radar attachment plate 111 corresponds to radar attachment plate 91 in attachment member 90 and radar attachment angles 116 and 117 correspond to radar attachment angles 96 and 97 in attachment member 90.

Radar attachment plate 111 includes a flat plate portion 112 and bent portions 113 and 114. Flat plate portion 112 corresponds to flat plate portion 92 in radar attachment plate 91 and bent portions 113 and 114 correspond to bent portions 93 and 94 in radar attachment plate 91. Second radar 62 is fastened to flat plate portion 112 with a bolt.

Radar attachment angles 116 and 117 are fastened to casing body 56 with a bolt. Radar attachment angles 116 and 117 are each provided with a long hole 118. Long hole 118 corresponds to long hole 98 provided in radar attachment angles 96 and 97. Bent portion 113 and bent portion 114 are fastened to radar attachment angle 116 and radar attachment angle 117, respectively, with a bolt 121 and a bolt 122.

With such an attitude adjustment mechanism, similarly to first radar 61, the attachment attitude of second radar 62 can be adjusted.

The construction and effects of hydraulic excavator 100 in the present embodiment described above will be summarized.

Hydraulic excavator 100 as the work vehicle according to the present disclosure includes traveling apparatus 15, revolution frame 31, and first radar 61 as the first obstacle detection sensor. Revolution frame 31 is mounted on traveling apparatus 15. Revolution frame 31 includes lower frame 32. First radar 61 is arranged on side surface 46 of lower frame 32 that extends in the fore/aft direction and is arranged on the left and the right. First radar 61 is provided at a position closer to rear end portion 32r of lower frame 32.

According to such a construction, first radar 61 is arranged on side surface 46 of lower frame 32 in revolution frame 31 mounted on traveling apparatus 15. Therefore, first radar 61 can be provided in the side portion of hydraulic excavator 100 and at a position closer to the ground. Since first radar 61 is provided at the position closer to rear end portion 32r of lower frame 32, first radar 61 can be provided as being further closer to the rear portion of hydraulic excavator 100. Thus, with first radar 61, capability to detect an object located in the rear of the side surface of hydraulic excavator 100 and at a position close to the ground can be enhanced.

First radar 61 includes first right radar 61R as the first obstacle detection right sensor and first left radar 61L as the first obstacle detection left sensor. First right radar 61R is arranged on right side surface 46R of lower frame 32. First left radar 61L is arranged on left side surface 46L of lower frame 32.

According to such a construction, with first right radar 61R and first left radar 61L, capability to detect an object located in the rear of the side surfaces on both of left and right sides of hydraulic excavator 100 and at a position close to the ground can be enhanced.

The distance between first radar 61 and rear end portion 32r of lower frame 32 in the fore/aft direction is shorter than the distance between revolution center axis 210 of revolution frame 31 and first radar 61 in the fore/aft direction.

According to such a construction, first radar 61 can be provided as being brought further closer to the rear portion of hydraulic excavator 100. Thus, with first radar 61, capability to detect an object located in the rear of the side surface of hydraulic excavator 100 can further be enhanced.

Lower frame 32 is provided with recess portion 45. Recess portion 45 is in the recessed shape in side surface 46 of lower frame 32 that is arranged on the left and the right. First radar 61 is accommodated in recess portion 45.

According to such a construction, even when large external force is externally applied to first radar 61, first radar 61 can appropriately be protected by lower frame 32.

First radar 61 emits radio waves to an area at angle α in the vertical plane. First radar 61 is provided such that the bisector of that area that bisects angle α extends from first radar 61 in the horizontal direction or the diagonally downward direction.

According to such a construction, with first radar 61, capability to detect an object located at a position close to the ground can further be enhanced.

Hydraulic excavator 100 further includes attachment member 90. First radar 61 is attached to lower frame 32 by means of attachment member 90. First radar 61 emits radio waves to the area at angle α in the vertical plane. Attachment member 90 is provided with an attitude adjustment mechanism. The attitude adjustment mechanism changes an attitude of attachment of first radar 61 to lower frame 32 such that the direction of extension of the bisector of that area that bisects angle α changes.

According to such a construction, in conformity with contents of works by hydraulic excavator 100, an environment around hydraulic excavator 100, or an object to be detected by first radar 61, an orientation of radio waves emitted from first radar 61 can be adjusted in the upward/downward direction.

A range of emission of radio waves from first radar 61 in revolution of revolution frame 31 is distant from traveling apparatus 15.

According to such a construction, erroneous detection of traveling apparatus 15 as an obstacle around hydraulic excavator 100 by first radar 61 in revolution of revolution frame 31 can be prevented.

Hydraulic excavator 100 further includes counterweight 51 and second radar 62 as the second obstacle detection sensor. Counterweight 51 is provided at the rear end portion of revolution frame 31. Second radar 62 is arranged on rear surface 52 of counterweight 51.

According to such a construction, with first radar 61 and second radar 62, capability to detect an object located in the rear of the side surface of hydraulic excavator 100 can further be enhanced.

Hydraulic excavator 100 further includes cab 14 and third radar 63 as the third obstacle detection sensor. Cab 14 is provided on lower frame 32. Cab 14 is provided at a position shifted to the left which is any one of the left and the right with respect to centerline 230 of lower frame 32 extending in the fore/aft direction. Third radar 63 is arranged on right side surface 46R of lower frame 32 arranged on the right which is any the other of the left and the right. Third radar 63 is provided at a position closer to front end portion 32f of lower frame 32.

According to such a construction, cab 14 where the operator rides is provided on the left of centerline 230 of lower frame 32 extending in the fore/aft direction. Therefore, the operator's viewability of the front of the side surface of hydraulic excavator 100 can satisfactorily be obtained. On the right of centerline 230 of lower frame 32 extending in the fore/aft direction, third radar 63 is provided at a position closer to front end portion 32f of lower frame 32. Therefore, with third radar 63, capability of detection in front of the side surface of hydraulic excavator 100 can be ensured.

The obstacle detection sensor in the present disclosure is not particularly limited so long as the sensor is able to detect an object such as a person or a structure around the work vehicle. For example, light detection and ranging (LiDAR), an ultrasonic sensor, or an infrared sensor may be applicable. The work vehicle in the present disclosure is not limited to the hydraulic excavator, and for example, a crane or the like is applicable.

It should be understood that the embodiment disclosed herein is illustrative and non-restrictive in every respect. The scope of the present invention is defined by the terms of the claims rather than the description above and is intended to include any modifications within the scope and meaning equivalent to the terms of the claims.

### REFERENCE SIGNS LIST

11 vehicular main body; 12 work implement; 13 revolving unit; 14 cab; 14S operator's seat; 15 traveling apparatus; 15B travel frame; 15Cr crawler belt; 15M travel motor; 16 boom; 17 arm; 18 bucket; 19 engine hood; 20A, 20B boom cylinder; 21 arm cylinder; 22 bucket cylinder; 23 boom pin; 24 arm pin; 25 bucket pin; 30 revolution apparatus; 31 revolution frame; 32 lower frame; 32f front end portion; 32r rear end portion; 33 bottom plate; 34 left rising portion; 34p outer plate portion; 34q inner plate portion; 35 right rising portion; 36, 37 vertical plate; 38, 39 pin insertion hole; 41, 42 protruding portion; 43, 54 opening portion; 45, 55 recess portion; 46 side surface; 46L left side surface; 46R right side surface; 51 counterweight; 52 rear surface; 53 dished portion; 93, 94, 113, 114 bent portion; 56 casing body; 61 first radar; 61L first left radar; 61R first right radar; 62 second radar; 63 third radar; 71 first camera; 72 second camera; 73 third camera; 74 fourth camera; 81, 82 lid portion; 88, 89 bolt insertion hole; 90, 110 attachment member; 91, 111 radar attachment plate; 92, 112 flat plate portion; 96, 97, 116, 117 radar attachment angle; 98, 118 long hole; 99 round hole; 100 hydraulic excavator; 101, 102, 121, 122 bolt; 210 revolution center axis; 220 pivot center axis; 230 centerline; 240, 240A, 240B, 240C, 240D first left radar detection area; 241, 242, 251, 252, 261, 262, 271, 272 bisector; 250 first right radar detection area; 260 second radar detection area; 270 third radar detection area; 310 shooting area; 320 stop control area; 330 detection area

1. A work vehicle comprising:
a traveling apparatus;
a revolution frame mounted on the traveling apparatus and including a lower frame; and
a first obstacle detection sensor arranged on a side surface of the lower frame, the side surface of the lower frame extending in a fore/aft direction and being arranged on left and right, the first obstacle detection sensor being provided at a position closer to a rear end portion of the lower frame.

2. The work vehicle according to claim 1, wherein
the first obstacle detection sensor includes
a first obstacle detection right sensor arranged on a right side surface of the lower frame, and
a first obstacle detection left sensor arranged on a left side surface of the lower frame.

3. The work vehicle according to claim 1, wherein
a distance between the first obstacle detection sensor and the rear end portion of the lower frame in the fore/aft direction is shorter than a distance between a revolution center axis of the revolution frame and the first obstacle detection sensor in the fore/aft direction.

4. The work vehicle according to claim 1, wherein
the lower frame is provided with a recess portion in a recessed shape in the side surface of the lower frame arranged on the left and the right, and
the first obstacle detection sensor is accommodated in the recess portion.

5. The work vehicle according to claim 1, wherein
the first obstacle detection sensor is a radar,
the radar emits radio waves to an area at an angle α in a vertical plane, and
the radar is provided such that a bisector of the area that bisects the angle α extends from the radar in a horizontal direction or a diagonally downward direction.

6. The work vehicle according to claim 5, further comprising an attachment member for attachment of the radar to the lower frame, wherein
the radar emits radio waves to the area at the angle α in the vertical plane, and
the attachment member is provided with an attitude adjustment mechanism that changes an attitude of attachment of the radar to the lower frame such that a direction of extension of the bisector of the area that bisects the angle α changes.

7. The work vehicle according to claim 5, wherein
a range of emission of the radio waves from the radar in revolution of the revolution frame is distant from the traveling apparatus.

8. The work vehicle according to claim 1, further comprising:
a counterweight provided at a rear end portion of the revolution frame; and
a second obstacle detection sensor arranged on a rear surface of the counterweight.

9. The work vehicle according to claim 1, further comprising:
a cab provided on the lower frame and provided at a position shifted toward any one of the left and the right with respect to a centerline of the lower frame that extends in the fore/aft direction; and
a third obstacle detection sensor arranged on a side surface of the lower frame arranged on any the other of the left and the right and provided at a position closer to a front end portion of the lower frame.
